(19) United States
(12) Patent Application Publication
(10) Pub. No.: US 2022/0285997 A1
(43) Pub. Date: Sep. 8, 2022

(54) METHODS, SYSTEMS, AND APPARATUSES FOR PRODUCING, GENERATING AND UTILIZING POWER AND ENERGY

(71) Applicant: MCIT DBA Saiyan Innovations, Tyler, TX (US)

(72) Inventors: Matthew Ryan HANKLA, Tyler, TX (US); Mary MCINERNY, Tyler, TX (US)

(73) Assignee: MCIT DBA Saiyan Innovations, Tyler, TX (US)

(21) Appl. No.: 17/686,517

(22) Filed: Mar. 4, 2022

Related U.S. Application Data
(60) Provisional application No. 63/156,458, filed on Mar. 4, 2021.

(51) Int. Cl. H02J 50/30

(52) U.S. Cl. CPC H02J 50/30; G06F 1/32

(57) ABSTRACT

Methods, systems, and apparatuses for generating, producing, and utilizing energy.

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

In a first embodiment, a Quantum Compute method, system, and apparatus may be provided.

This exemplary embodiment may include a blaster, a power core, a combination of coatings, and a reaper. When assembled, this exemplary embodiment may store, transmit, manage, and manipulate digital information faster and more efficiently than prior computation devices. With this increase in efficiency, this exemplary embodiment may be used in security systems, quantum computers, or any other type of device that transmits, manages, manipulates, and/or stores digital data.

### EXEMPLARY STRUCTURE

The materials that make up this exemplary embodiment may be combined with a circuitry component that relays a message to pulse the blaster at a specific frequency. As light is pulsed within the exemplary embodiment, it is amplified by the power core and then harnessed by the reaper. The reaper converts this generated light into useable electricity that can then be cycled back into the associated circuitry to power the light emitting devices within the exemplary embodiment. This cycle of power may self-sustain the exemplary embodiment allowing the device to operate on its own without the need of an external power source.

Initially, an external power source may be necessary to jump-start the exemplary embodiment. For instance, a reaper, or any other device that emits electric current may be needed to initially power the first blaster. Once jump started, the exemplary embodiment may continue to emanate photonic energy and perpetually supply electric current to power itself, as well as an external computation device.

The materials that make up this solid-state exemplary embodiment may be layered in such a way that is intrinsic to the digital system that it is working with. This means that it may be layered with multiple power cores and reapers that allows for the transmission of data in the form of synchronous pulsed light. For instance, if this solid-state exemplary embodiment were to be placed inside the circuitry of a computation device that is meant to relay large amounts of digital information, there would need to be a relatively large amount of power cores available to readily distribute pulses of light for every computation algorithm made in the solid-state device. Consequently, there would need to be a larger number of photoelectric materials as well that are readily able to harness this distributed light and convert it back into useable electricity to either power the pulsation lights within the computation device, as well as the device itself.

The order and orientation of these materials that make up this exemplary embodiment may be as follows, or it may be any other combination of these materials that allows for the most seamless conversion of digital information and self-sustainment of power within this exemplary embodiment.

Blaster: A light source that may emit photonic energy at a specific wavelength that is most readily absorbed by the power cores within the solid-state device. The blaster may emit light in the form of constant wave or at a specific timed pulse determined by the circuitry associated with this exemplary embodiment.

The materials that make up the blaster may include a photodiode, that may be made from elements from groups III and V in the periodic table. These elements may include, but are not limited to GaAs, InGaN, GaP, or any other type of photo-illuminating material that emits wavelengths of light that are within the absorption spectrum of the power cores.

The blasters may also be connected to the circuitry within the solid-state exemplary embodiment. Therefore, when a specific code needs to be sent through the system, the blaster may be pulsed at a specific frequency to generate enough photonic energy within the power cores to be readily absorbed by the photoelectric material and then converted into electrical energy within the circuitry to either open or close the associated gate.

The pulsation of light emitted by the blasters are what allows for certain messages or data to be transmitted in this solid-state exemplary embodiment. Once the blaster pulses a specific frequency of light, the signal transduction pathway for information has begun and a cascade effect will follow.

The blaster may also be oriented in such a way that it is fixed to the most photoreactive portion of the power core. This may allow for optimal transmission of photonic energy from the blaster into the crystalline lattice structure of the power cores for absorption and amplification.

The photoreactive portion, or also referred to as the absorption face, of the power core may be polished at a specific incident angle to allow for seamless transmission of light from the blaster to enter the crystalline lattice structure of the material. This may decrease reflection losses and may increase overall efficiency of the solid-state exemplary embodiment as photonic energy emitted by the blaster is readily absorbed by the power cores.

Power Core: A certain crystalline lattice structure that may allow for the even distribution and amplification of photonic energy within this solid-state exemplary embodiment. The blaster may emit a certain wavelength or bandgap of light at a specific timed frequency, at constant wave, or with any other delivery method that allows for the crystalline lattice structure of the power core to reach optimal saturation power. Once the power core has become saturated with photonic energy, stimulated emission (Saiyan Emanation) may take place within the structure. This allows for the amplification and even distribution of photonic energy within the solid-state exemplary embodiment.

Exemplary materials that make up the power core may include Ti³⁺: Al₂O₃, Nd: YAG, Ce: YAG, Er: YAG, Nd: YVO₄, or any other type of crystalline lattice structure that allows for the amplification of photonic energy within the solid-state exemplary embodiment.

Materials that are used within the solid-state embodiment, may be chosen based upon the needs of the computation device. If the device requires large amounts data to be transmitted very quickly, the device may require a crystalline lattice structure that reaches saturation very quickly and may also have a high associated gain potential.

The more photonic energy that is readily absorbed and amplified by the power core, the more electrical energy will be available for sustaining the reactor, as well as modulating the associated gate within the circuitry.

The power core may become saturated with photonic energy via the blasters through the process of q-switching, gain switching, mode-locking, or any other type of pulsation of photonic energy that allows for the crystalline lattice structure to reach its gain potential as quickly and efficiently as possible.

Reaper: The reaper may be formed of a photoelectric material and positioned where it may harness the photonic energy emitted by the power core. As the power core evenly distributes the pulsed photonic energy, the reaper may collect this photonic energy and simultaneously convert the energy into useable electrical energy. The reaper may also be connected to the circuitry associated with this exemplary embodiment. As the reaper collects photonic emitted by the power core, the energy may either be used to power the blasters, or it may be stored within the associated circuitry and used to transmit and store digital information.

The reaper may be formed of a variety of different crystalline photoelectric materials. These include GaAs, InGaN, mono or polycrystalline silicon, CdTe, or any other type of chemical combination that may readily convert photonic energy into electrical energy.

The crystalline lattice structure of the reaper may also be index matched and positioned so that its orientation matches the crystalline orientation of the power core. This may decrease the amount of reflection losses within the system and allow for seamless transition of photonic energy throughout the solid-state exemplary embodiment.

The reaper may also be formed of circuitry that connect the newly converted electrical energy to the blasters in the solid-state exemplary embodiment, and the computation device. This allows for the solid-state device to both sustainably continue to power itself, while still powering its associated computation device.

Coatings: Another component of this solid-state exemplary embodiment may include the use of specialized coatings that aid in the seamless transmission of light throughout the device. These coatings may also be used to either transmit or reflect specific wavelengths of light depending on their structure and location within the exemplary embodiment.

Highly reflective coating: This type of coating may be used on one, multiple, or all faces of the power core, blaster, reaper and/or any other material that transmits light within the exemplary embodiment. This coating may include two materials: one with a high index of refraction and one with a low index of refraction. Zinc sulfide, titanium dioxide, or any other chemical combination that has a high index of refraction may be used in combination with magnesium fluoride, silicon dioxide, or any other chemical combination with a low index of refraction. This coating may be tuned to reflect light at specific wavelengths and tailored towards the pathway of light through the solid-state exemplary embodiment. Tuning of the coating may be accomplished through determining a specific ratio between the two indices. These differences in refractive indices are what may allow for constructive interference that maximizes reflection of some wavelengths, while minimizing reflection in others.

The purpose of this coating in this solid-state exemplary embodiment may be to trap wavelengths of light that are within the peak absorption bandgap for the material that makes up the power core. By selectively trapping this spectrum of light, the system may amplify a larger quantity of photonic energy thereby increasing the overall optical power output potential of the device.

This coating may also be placed on the back side of the reapers as well. The purpose of this placement would be to decrease the overall loss of photonic energy that may exit the photoelectric material, before having the chance to become absorbed. This increases the overall amount of available photonic energy that may be harnessed and converted into useable electrical energy within the exemplary embodiment.

Antireflective Coating: This type of coating may be used on one, multiple, or all faces of the power core, blaster, reaper and/or any other material that transmits light within the exemplary embodiment. The coating includes different layers of materials with varying refractive indices. Each layer in the coating stack combines with the previous layer to introduce destructive waves that are out of phase with the light waves that encounter the coating. This is accomplished through creating a reflection from the second surface that may be half the wavelength out of the phase from the initial reflection. This may create two reflections which cancel each other out allowing for most light to transmit through to the power core. Like the highly reflective coating, this coating may be tuned to allow for certain wavelengths of light within a specific bandgap to pass through with minimal reflection, while interfering with others. This selection of wavelengths may be dependent upon the location of the AR coating within the exemplary embodiment, as well as what wavelengths of light the coating may encounter.

The purpose of this coating would be to decrease the amount of photonic energy that is lost from reflection as it travels from one medium to another. For instance, within this solid-state embodiment, there may be significant reflection losses when photonic energy exits the power core and enters the absorption face of the reaper. If an AR coating were to be placed on either the exit face of the power core, or on the absorption face of the reaper, total reflection losses within the device may be substantially minimized.

Index matching coating: One of the many forms of an antireflective coatings may also be deposited onto the absorption face of the reaper, or the emission face of the blaster, and may be used has a method to decrease the total amount of reflection losses within this solid-state exemplary embodiment. This index matching coating may be accomplished through the deposition of different chemical compositions with varying refractive indices. The selection of chemical compound may be dependent upon the refractive indices of the reaper, power core, and/or blaster. There may be a gradient of varying refractive indices each lying between the refractive indices of the power core and the reaper, and/or the power core and the blaster. There may be one or multiple layers of this coating within this solid-state exemplary embodiment.

The purpose of this index matching coating is to decrease the amount of photonic energy lost as it transitions from the excitation face of the power core onto the absorption face of the reaper. This increases the overall transmission of photonic energy into the reaper stimulating the materials ability to undergo the photoelectric effect producing usable electrical energy.

This coating may also be deposited between the emission face of the blaster and the absorption face of the power core to increase the overall transmission of photonic energy from the blaster into the power core for amplification.

Dichromatic coating: This type of coating may be used on one, multiple, or all faces of the power core, blaster, reaper and/or any other material that transmits light within the exemplary embodiment. This dichromatic coating, also referred to as a dichroic filter, may be effective by producing destructive interference with specific wavelengths in the electromagnetic spectrum. Destructive interference is accomplished through using altering refractive indices to produce phased reflections, thereby allowing certain wavelengths of light to transmit while interfering with other wavelengths. Therefore, during destructive interference, light of a particular wavelength is unable to permeate the coating and is instead reflected off. Light of a differing wavelength may then transmit through the coating depending upon the refractive indices of the chemical compounds used to construct the coating. These coatings may be engineered to target wavelengths within the peak absorption and peak emission bandgaps of the power core, reaper, blaster, or any other material that is used to transmit photonic energy within the solid-state exemplary embodiment.

Bandpass Filter: Multiple different types of dichromatic coatings may be used on one, multiple, or all faces on the power core, blaster, reaper and/or any other material that transmits light within the exemplary embodiment This is a type of dichromatic coating that differs in the sense that it allows for more specific tunability of the coating when relating to the selection of wavelengths it will reflect or transmit. A bandpass filter may reflect and transmit multiple different wavelengths at varying spectrums. The angle at which light penetrates or reflects from this filter is dependent upon the angle at which the coating is oriented. Therefore, its effectiveness may increase if the angle of incident were to match the incident angle of which the filter is receiving light.

The purpose of this filter is its ability to transmit and reflect light at varying spectrums. This allows for the coating to operate more specifically to the performance metrics dictated by the peak absorption and emission wavelengths of the power core, blaster, reaper, and/or any other material within the exemplary embodiment that is involved in the transmission of light.

The solid-state exemplary embodiment may be configured in a way that may allow for the transmission, storage, processing, structuring, and managing of digital information at increased efficiencies. This may be accomplished through the unique manipulation and harnessing of photonic energy that takes place within the photosensitive materials of the exemplary embodiment. Each structure may be oriented in such a way that allows for the seamless transmission, collection, and emission of specific wavelengths of light at extremely high efficiencies.

The solid-state exemplary embodiment may operate as a cascade of photonic interactions each stimulated by the integrated electrical circuitry. This would mean that the photonic reactions that occur throughout the device are each stimulated by electrical circuitry, while the electrical circuitry itself is powered by the stimulated photonic reactions.

As a photonic reaction is initiated, one and/or a series of blasters may emit a specific monochromatic or polychromatic beam of light. The wavelength or spectrum of light emitted by the blaster is dependent upon the peak absorption spectrum of the power core. The blasters are therefore engineered to produce the most effective spectrum of light that is most readily absorbed by the material that makes up the power core.

The light may be emitted via a timed pulse at a specific frequency relayed through the circuitry, or it may be a constant wave of photonic energy. The method of which the light is delivered is dependent upon the material used for the power core and which delivery method creates the largest gain potential. This beam of light mat be gaussian, coherent, and/or distributed in any other effective manner that allows this light to enter the power core most efficiently. The power core may then evenly distribute the photonic energy across the face.

By allowing for the seamless transmission of selected wavelengths of light, the potential for stimulated emission (Saiyan Emanation) within the power core is created. Because the power core may have a high absorption efficiency for this specific bandgap of light, electrons throughout the crystalline lattice structure may become energized. As the electrons become energized, they may move from their charged position, to a discharged energy level. This movement of electrons may consequently release energy in the form of photons. These photons make up the photonic energy that is emitted from the power core. This photonic energy is then focused on the face of the photoelectric material. Optical coatings may be used in this junction to decrease the total amount of reflection losses as the light exits the power core and enters the reaper. Optical coatings may also increase the transmissive ability of the reaper as well, allowing for the solid-state exemplary embodiment to utilize as much of the emanated photonic energy as possible.

Photonic energy emanated by power core may then become absorbed by the reaper to be converted into electrical energy via the photoelectric effect. The photoelectric material may be made up of a composition of photosensitive molecular compounds that have a high absorption efficiency for the spectrum of light that is illuminated by the power core. As the photoelectric material absorbs this spectrum of light, the photonic energy may then stimulate the movement of electrons within the material. These freely flowing electrons then travel down the material in the form of an electric current. This transition from photonic energy into electrical energy is known as the photoelectric effect. This electric current can then be processed through a circuit board in the form of usable energy that can be applied in a variety of use cases. Some of these use cases may include providing a current to stimulate the blaster to emit light, thereby allowing the solid-state exemplary embodiment to become self-sustaining. This electrical current may also be used to stimulate photonic reactions that may transmit, process, receive, or manage digital information in the computation device. This may be accomplished through a cascade effect of photonic reactions that stimulate the blaster to emit light at a specific frequency. Electrical current may also be stored throughout the circuitry in capacitors, or any other electrical storage device. The stored electrical current may be used to regulate energy flow and may allow for specialized computation processes.

The exemplary embodiment may include one or multiple blasters, power cores, and reapers. Therefore, as temperature conditions become less than ideal, there may be a sensor within the circuitry that triggers reactions within a specific power core to stop, triggering the next power core to illuminate to continue creating stimulated pulses of photonic energy. The modulation in photonic interactions within each blaster, power core, and reaper may decrease the potential for heat damage, and increase the overall efficiency of the system.

Another exemplary embodiment is formed of a variety of materials that may be formed of a variety of different molecular and chemical compounds. Each molecular and chemical compound is intrinsic to the solid-state device in the sense that these chemical bonds are what allow for the emanation of photonic energy and its efficient conversion into usable electrical energy.

Blaster: The blaster is made of a semiconductor compound that emits a specific wavelength of photonic energy when an electric current passes through the material.

Semiconductor materials: Blasters may be include a compound of semiconductor materials that may include elements from groups III and V on the periodic table. Some compounds may include, but are not limited to InGaN, AlGaInP, AlGaAs, and GaP.

These semiconductor materials may be deposited as very thin layers. One layer may have an excess amount of electrons, while the subsequent layer may have a deficient number of electrons. These are known as electron holes. The difference allows for electrons to flow and fill the holes in the deficient layer, emitting photonic energy as they become displaced and enter a different energy level.

The layers of semiconductors may also be manufactured with impurities that increase the rate at which the electrons flow from each layer. This is also known as doping. During the manufacturing process, zinc, nitrogen, silicon, germanium, tellurium, or any other element that increases the rate that the blaster may emanate photonic energy. The doping allows for the semiconductor material to conduct electricity through creating either a deficit or excess in electrons.

The blaster may be tuned to emit a specific bandgap of light. This bandgap may be wide or narrow depending upon semiconductor materials used. Each chemical compound used in the semiconductor has a different emission bandgap. This emission bandgap may be tuned to match the absorption spectrum of the chemical compounds used to make up the power core. By matching these bandgaps, photonic energy can transition from the blaster into the power core at high efficiencies with minimal reflection losses.

The selection of chemical compounds that make up the semiconductor material may be dependent upon the desired emission wavelength for the blaster. Once a bandgap is selected, a chemical compound that emanates this spectrum may be selected.

Growth Process: The crystalline semiconductor material may be grown in a high temperature, high pressure chamber. The main semiconductor materials, such as gallium, arsenic, and phosphorus may be subject to high heat and high pressure causing the components to liquefy and mix together. A solution, such as boron oxide, may then be deposited over the surface preventing the components from the mixture to escape as a gas, causing the solution to stick together. Once the solution has been mixed, a long rod may then be dipped into the solution and slowly removed creating a cylindrical crystal boule of GaAs, GaP, GaAsP, or any other crystalline semiconductor compound.

Once the boule has been grown, it may be sliced into extremely thin wafers. The wafers may be polished to a clean and clear surface finish. Polishing may be necessary when layering the semiconductor materials so that they may effectively electrons from one wafer to the next. Polishing may also allow for the blaster to emit a much cleaner beam profile as imperfections are mitigated.

Once polished, the wafers may then be ultrasonic cleaned with various solvents. The cleaning prevents impurities from creating inefficiencies in the blaster and may yield a cleaner beam profile.

Once the first layer is created, additional layers may be grown on the clean, polished surface. These additional semiconductor layers may have the same orientation as the subsequent layer below and may be epitaxially deposited as the wafer as it is exposed to reservoirs of molten GaAsP. These reservoirs may also include dopants, such as zinc, nitrogen, silicon, germanium, tellurium, or any other element that increases the rate that the blaster may emanate photonic energy. The wafer may be set on a graphite slide as the molten liquid is deposited over the surface.

Additional layers may be added to alter the emission wavelength as well.

Additional dopants may add as well to alter the emission wavelength. Dopants may also be added to increase overall efficiency as well.

Additional doping: If additional doping is needed, the wafer is placed in a high temperature, high pressure furnace tube, where it is exposed to dopants in their gaseous state. Nitrogen, zinc ammonium, or any other chemical compound that increases overall efficiency may be used as a dopant.

To carry an electric current, the blaster may be configured with wires that may effectively carry an electric current. Some elements that may be used include gold, silver, copper, or any other highly conductive element or chemical compound. These conductive wires may also form chemical bonds with the semiconductor material, such as the gallium, allowing for efficient transfer of electricity.

Packaging: Blasters may be packaged individually or in series, depending upon which orientation allows for the greatest amount of photonic energy to emanate within the power core.

Blasters may also be assembled in glass or plastic casings as well. The casing may include optical coatings or may be made of a specific material that increases beam and transmission quality.

Coating: The blaster may also require an optical coating deposited over its top layer. This may be necessary to properly index match the top surface of the blaster to the power core, or to whatever medium the blaster is emitting photonic energy into. By matching the index of refraction, photonic energy can readily exit the blaster and enter the power core at high efficiencies with minimal reflection losses.

Power Core

Crystalline-Lattice structure: This molecular compound may have a specific orientation and lattice structure that may have an associated gain potential. When the material is exposed to light in its peak absorption bandgap at a specific frequency, stimulated emission (Saiyan Emanation) may occur within the power core, emanating newly generated photonic energy in the form of the medium's peak emission spectrum.

Possible crystals: There are many crystals that may have gain potentials that embody the characteristics listed above. Some of these crystals may include Ti³⁺: Al₂O₃, Nd: YAG, Cs: YAG, or any other crystal/chemical compound with an intrinsic gain potential.

The power core may be cut, fabricated, polished, and coated before it is able to effectively provide a gain potential.

The power core may be spherical, rectangular, triangular, or any other type of crystalline configuration that allows for the harnessing and amplification of photonic energy.

The power core may also be polished at a specific incident angle that may allow for the seamless transmission of light with minimal reflection losses. This angle may be a Brewster Angle, or any other type of configuration that decreases reflection and allows for seamless transmission of light into the power core.

The face at which this polishing takes place may also be known as the absorption face of the power core. This may also be where the emission face of the blaster is adhered to as well. By using this highly absorbent incident angle within the power core

Photoelectric Material

This is the site where the photoelectric effect takes place within the solid-state device. The material that is used here may be highly excitable by photonic energy. The material may also be specifically excited by specific wavelengths of light. For instance, this material may be selectively excited by the peak emission bandgap of the power core associated with this solid-state device. This allows for the newly created photonic energy from the power core to excite the electrons within the photoelectric material generating a useable electric current.

Chemical composition: This material may include a variety of different chemical or molecular compositions. Of which, specific chemical or molecular compounds such as GaAs, InGaN, GaInP, polycrystalline silicon, SiN, CdTe, or any other chemical compound that can partake in the photoelectric effect. Another important characteristic of the material may be for its peak absorption bandgap to match the associated power core's peak emission bandgap.

Assembly: This material may be coated with an antireflective coating, dichromatic coating, or any other coating that decreases the amount of photonic energy that is lost due to reflection. This prevents the loss of photonic energy that is necessary to stimulate the movement of electrons within the material. By having this coating, the necessary light is directed and evenly distributed across the faces of the photoelectric material. This increases the instances of freely moving electrons allowing the conversion of photonic to electrical energy to become increasingly more efficient. There may also be a highly reflective mirror that lies on the back of the solid-state device. This allows for light not initially absorbed by the power core to be directed back into the crystal to initiate continued stimulated emission.

Coatings may be deposited using electron beam physical vapor deposition, ion assisted deposition, ion beam sputtering, or any other type of coating deposition process that allows for the effective distribution of coatings onto the faces of the photoelectric material.

The coatings may be evaporated evenly over the faces of the photoelectric material. This allows for the coating to evenly act on the entire face of the material increasing the amount of available surface area for the reaper effect to continuously occur. The photoelectric material is then effectively adhered to the back of the power core. This may be done using a resin whose index of refraction matches the power core allowing for light to seamlessly pass through onto the face of the photoelectric material.

As light enters the power core, it may allow for stimulated emission (Saiyan Emanation) to occur within the power core. Newly generated energy may exit the medium in the form of its peak emission bandgap. This light may then become readily absorbed by the photoelectric material. Once the photonic energy undergoes the photoelectric effect within this material, electrical energy may be harnessed and implemented into a variety of use cases

Coatings

Dichromatic Coating: This may include a variety of different materials. The chemical or molecular compound is selectively permeable to light that is within the peak emission wavelengths of the sun. This wavelength consequently may also be within the bandgap of the solid-state device's power core's peak absorption.

This coating is applied to the polished surface of the power core. There are multiple ways to adhere this coating to the exemplary embodiment. One of which includes evaporating the chemical or molecular compound evenly across the surface. This allows for the coating to bond to the material seamlessly which may enhance its overall effectiveness.

There are a variety of processes that may be used to evaporate this compound onto the surface of the substrate. Some of which include, but are not limited to, electron beam sputtering, electron beam physical vapor deposition, ion assisted deposition, ion beam sputtering, or any other type of optical coating process that allows for the effective distribution of dichroitic coatings.

A possible process when using an ion beam sputtering technique is as follows:

Using a vacuum chamber and a target material (a metal oxide or any other type of material that releases electrons), a high energy ion beam is directed at the target. The ions within the beam may transfer their momentum into the target material causing atoms or molecules to sputter off. These high energy atoms/molecules that may sputter off the target material may deposit onto the substrates. Uniform, high density coatings may be achieved due to the presence of low-pressure oxygen within the coating to re-oxidize any free molecule or atom that may have become dissociated during the sputtering process.

The resulting coating may be an extremely smooth, clean surface finish that may also withstand temperature and humidity fluctuations within its environment.

Anti-Reflective Coatings: These coatings are applied to the faces of the power core and the photoelectric material. Having both materials coated with this anti-reflective coating may allow for the solid-state device to decrease its overall loss in photonic energy. They allow for the materials to reach the point of saturation and then allows the light to exit to prevent over saturation.

This coating is applied to the polished surface of the power core. There are multiple ways to adhere this coating to the exemplary embodiment. One of which includes evaporating the chemical or molecular compound evenly across the surface. This allows for the coating to bond to the material seamlessly which may enhance its overall effectiveness.

There are multiple ways to effectively bond this type of coating upon the surface of the substrate. For instance, electron beam sputtering, electron beam physical vapor deposition, ion assisted deposition, ion beam sputtering, or any other type of coating process that allows for the effective and efficient deposition of antireflective coatings upon the surface of a substrate. When using electron beam sputtering, a possible adhering process is as follows.

To initiate this process, the coating material may be heated within a high vacuum chamber until it becomes vaporized. It may be heated through electron beam bombardment when using dielectrics, or it may be heated resistively when using metals. As the coating material vaporizes, vapor may then stream away and recondense onto the surface of the substrate intended for coating.

Another process that may be utilized when using electron beam sputtering includes electron-beam physical vapor deposition. This may allow for coating at a high deposition rate without needing to heat the substrate at such high temperatures. When initiating this coating process, an electron beam may be generated and accelerated to a high kinetic energy. This high energy beam may then be directed at the evaporation material causing the electrons within the material to decrease unto a lower energy level. Interactions with the evaporation material causes kinetic energy to become converted into alternative forms of energy. Thermal energy may be one of the alternative forms of energy and may conduct heat into the evaporation material causing it to melt. The melt may then vaporize and rise to coat the surface of the substrate.

Highly Reflective Coatings: This may include a variety of different materials. The chemical or molecular compound may act as a mirror within the solid-state device. This coating's reflective properties that may either reflect all wavelengths or may selectively reflect light that is within the power core's peak absorption bandgap. This allows for the continuous stimulation emission within the power core of the solid-state device. As the initial photonic energy saturates the material and exits, excess photonic energy may then be reflected to initiate stimulated emission within the power core.

This coating may be located on the side furthest from the surface dichromatic layer. This allows for the ability for enhanced trapping of the power core's primary excitation wavelengths. With this ability to control and reflect this light, the exemplary embodiment's ability to initiate stimulated emission may be substantially improved.

This coating is applied to the polished surface of the power core. There are multiple ways to adhere this coating to the exemplary embodiment. Of which may include, but are not limited to, electron beam sputtering, electron beam physical vapor deposition, ion assisted deposition, ion beam sputtering, or any other type of coating process that allows for the effective and efficient deposition of highly reflective coatings upon the surface of a substrate.

A possible process when using an ion beam sputtering technique is as follows:

Using a vacuum chamber and a target material (a metal oxide or any other type of material that releases electrons), a high energy ion beam is directed at the target. The ions within the beam may transfer their momentum into the target material causing atoms or molecules to sputter off. These high energy atoms/molecules that may sputter off the target material may deposit onto the substrates. Uniform, high density coatings may be achieved due to the presence of low-pressure oxygen within the coating to re-oxidize any free molecule or atom that may have become dissociated during the sputtering process.

The resulting coating may be an extremely smooth, clean surface finish that may also withstand temperature and humidity fluctuations within its environment.

In another exemplary embodiment, an Empyreal Reaper may be provided.

This solid-state exemplary embodiment may include a variety of different materials that allow for the conversion of photonic energy into electrical energy. These materials may include a composition of coatings, a gain medium, a resin, and a photoelectric material. The exemplary embodiment may be configured in such a way that allows for the harnessing of ambient photonic energy, and its conversion it into clean, useable electrical energy. This solid-state exemplary embodiment may be composed of a variety of different materials that allow for the conversion of photonic energy into electrical energy. These materials may include a composition of coatings, a gain medium, a resin, and a photoelectric material. The exemplary embodiment may be configured in such a way that allows for the harnessing of ambient photonic energy, and its conversion it into clean, useable electrical energy.

Structure

This exemplary embodiment has a structure that may contain the following various materials. A possible design and order for these materials are as follows. The solid-state exemplary embodiment may contain only one, a combination, or all the following materials.

This exemplary embodiment may be enclosed in a hermetic packaging that may allow for protection against environmental changes.

The order of which these materials are assembled may be the order as follows or may be any other order that allows for the most effective conversion of photonic energy into electrical energy. The orientation of these materials may be layered and may include different types of glass, an atomic mirror, multiple gain mediums, photoelectric materials, coatings and/or resins.

Glass casing: This exemplary embodiment may be encapsulated behind a protective glass shielding that allows for light to readily transmit through the material, while protecting the structure from environmental changes such as temperature, as well as climate alterations.

Ridged Mirror: An atomic mirror that captures light at a variety of indices and culminates this light into a coherent beam. This allows for the system to capture sunlight at varying incident angles and focus this light into one beam with the same incident angle most readily absorbed by the medium behind the mirror.

This structure allows for the exemplary embodiment to absorb a larger portion of ambient sunlight and may decrease the amount of reflection losses upon entry as the light is columnated into one coherent beam that is more readily absorbed by the exemplary embodiment.

Dichroic mirror: A chemical composition of various materials that may be semipermeable to specific wavelengths of light. For instance, this may include wavelengths intrinsic to the gain medium's peak absorption bandgap.

These various materials may be composed of alternating layers of optical coatings that have varied refractive indices. The variation in indices may allow to produce phased reflections that are tuned to allow specific wavelengths of light to permeate the material, while reflecting all other wavelengths.

Those wavelengths allowed to permeate the material, may allow for the potential for stimulated emission (Saiyan Emanation) of newly generated photonic energy within the gain medium. These wavelengths may be intrinsic to the peak absorption bandgap of the gain medium. As the gain medium readily absorbs these wavelengths, the electrons within the crystalline lattice structure may become energized and displaced from their current energy level. The displacement of electrons and their movement from a charged to discharged position, is what may allow for the generation of new energy.

This material may also be tuned to reflect wavelengths of light that are within the gain medium's peak emission bandgap. The newly generated energy from the potential Saiyan Emanation within the gain medium may exit the material in the form of light. The wavelength of this light may be within the gain medium's emission bandgap; and may be absorbed by the photoelectric material within the solid-state device.

This coating may also act as a layer of protection for the solid-state device. The chemical or molecular composition of the coating will reflect wavelengths of light that cause degradation within the exemplary materials of the solid-state device. Heat and infrared/ultraviolet spectrum light may be reflected to achieve this substantial decrease in degradation.

Cold Mirror Coating: A chemical composition of various materials tuned to reflect a high percentage of light within the UV spectrum, or any other spectrums of light that are unwanted within the solid-state exemplary embodiment at a specific incident angle (for example at a 45-degree incident angle). It may also be tuned to transmit a high percentage of light within the visual spectrum, or any other spectrum of light that is wanted within the solid-state exemplary embodiment at a specific incident angle (for example at a 45-degree incident angle).

It may also simultaneously reflect the same light it may transmit when these wavelengths permeate the mirror at an opposing incident angle (for example at a 0-degree incident angle). This is important for the spectrum of light that is within the peak absorption spectrum of the gain medium. When light in this absorption spectrum enters the coating at a specific incident angle, (for example at a 45-degree incident angle), the light may permeate the coating and enter the solid-state exemplary embodiment. The light that is within the absorption spectrum but is not absorbed by the gain medium that would normally be reflected out of the system, may instead by reflected by the design of the cold mirror. This is because this light may exit the material at a specific incident angle (for example at a 0-degree incident angle). The mirror may be tuned to these specific incident angles in order to capture wavelengths of light within the peak absorption spectrum of the gain medium and trap it within the system.

This mirror may allow for the creation of a virtual resonating cavity within the solid-state exemplary embodiment. This is important for the gain medium as this is the sight at which Saiyan Emanation may take place. The more light that is available for the gain medium to absorb reach saturation potential, the more photonic interactions may take place.

Anti-reflective coating: A chemical composition of various materials that may tuned to allow for wavelengths of light within the peak absorption bandgap of the gain medium to seamlessly pass through the material with minimal reflection losses. The allowing for a higher percentage of light within this specific spectrum may create the potential for stimulated emission (Saiyan Emanation) of newly generated photonic energy.

This may be composed of a variety of different materials. The chemical or molecular compound may effectively transmit the specific wavelengths of light that are within the peak absorption bandgap of the gain medium. This coating may also decrease the amount of photonic energy that is lost, while increasing the amount of available photonic energy to initiate the stimulated emission within the gain medium. This may be completed by the AR coating's ability to effectively produce two reflections that interfere destructively with one another allowing for a higher percentage of light within a specific bandgap to permeate the material with minimal reflection losses.

Once the materials within the solid-state device reach saturation, this coating may allow for the excess light to escape. This may decrease the potential for the material to become oversaturated.

Gain medium: A crystalline lattice structure whose peak emission bandgap may match the peak absorption bandgap of the chemicals that make up the material with high photoexcitation characteristics. This crystalline lattice structure may also have a gain potential associated with its peak absorption bandgap. This gain potential is what may allow for the stimulated creation and emission of new photons. These new photons may then exit the material in the form of the gain medium's peak emission bandgap.

The gain medium may be comprised of various chemical compounds that bind together in a mono or polycrystalline lattice structure. These may include synthetically grown or naturally occurring crystals that have certain optical properties. Some examples include Nd: YAG, Y²⁺: CaF₂, Ti³⁺: Al₂O₃, Nd: KGW, or any crystal, ion-oxide, or metal oxide that has photoexcitation properties.

Resin: a chemical composition of various materials that allow for the adhesion between the layers of materials within the exemplary embodiment. The resin may contain an index of refraction that is intrinsic to the index of refraction of the gain medium, or any other material that the resin is adhering together. The matching of refractive indices allows for the seamless transition of light from the different layers of materials within this solid-state exemplary embodiment.

Encapsulant: a chemical composition of various materials that allow for the adhesion between layers of materials within the exemplary embodiment. The encapsulant may contain an index of refraction that is intrinsic to the index of refraction of the gain medium, or any other material that the resin is adhering together. The matching of refractive indices allows for the seamless transition of light from the different layers of materials within this solid-state exemplary embodiment. The encapsulant may also function as a protective layer, decreasing the risk for delamination, corrosion, and environmental damage within the solid-state exemplary embodiment.

Antireflective coating: a chemical composition of various materials that contain varying refractive indices that are tuned to minimize reflection losses when specific wavelengths of light permeate a material. The purpose of this chemical composition is to match the refractive indices of the varying materials within the solid-state device. The matching of refractive indices between materials allows for a higher percentage of light to pass from one material to another with minimal losses resulting from reflection.

Photoelectric material: chemical composition of various materials that become excited by photonic energy in the peak emission bandgap associated with the gain medium. This excitation wavelength may stimulate the movement of free electrons from their bonded state. These free electrons travel together in one coherent current. This current is transferred from the photoelectric material into the circuitry components. At this stage, the photonic energy may be converted into usable electrical energy.

Highly Reflective coating: This coating acts as a mirror that may have reflective capabilities for the wavelengths of light that are within the peak absorption bandgap of the gain medium. This reflective coating allows for the materials within the solid-state device to reach their saturation capabilities. This increases the ability for the gain medium to undergo increased instances of stimulated emission.

Junction Box: A junction box may also be incorporated into the circuitry components of the solar panel. The junction box may regulate the electricity flow from each individual panel allowing for effective transition of electrons from the reaper material into the circuitry components. It may also allow for the user to dictate the performance of each individual solar panel. If one panel appears to have an alteration in its electron output, the user may identify which panel is having this issue and address it.

The junction box may digitalize the performance of each solar panel. The user may be able to enable or disable any of the associated panels with the use of software. There may also be opportunities for the system to be run by a computer and have certain parameters for electron flow that is regulated by computation.

This exemplary embodiment may have the ability to sustainably convert photonic energy into usable electrical energy. It may consist of a variety of materials that may have certain photoexcitation properties. For instance, the gain medium may be composed of various chemical compounds that together form a crystalline lattice structure that has photoexcitation properties. This molecular compound may have a specific orientation and lattice structure that allows for the process of spontaneous emission to be controlled and modified into stimulated emission (Saiyan Emanation). When wavelengths of light that match this material's specific peak absorption range interact with the substrate, the photons may have the ability to indirectly interact with the electrons within the gain medium. When this interaction takes place, the electron becomes excited and becomes energized. As the electron moves, it releases energy in the form of photons. These newly generated photons may be synonymous with the newly generated light that is illuminated from the gain medium. This newly generated light is what is converted into usable, electrical energy by the photoelectric material within the solid-state device.

As stated previously, the solid-state device may be comprised of none, one, or several different coatings. These coating may be a dichromatic coating, an antireflective coating, or any other type of coating that allows for photonic energy to seamlessly enter the gain medium. The coating may also simultaneously have reflective properties to specific wavelengths as well.

If a dichroic mirror is used, it may be tuned to transmit light that is within the gain medium's peak absorption bandgap, while reflecting light that is within the gain medium's peak emission bandgap. By allowing for the seamless transmission of selected wavelengths of light, the potential for stimulated emission (Saiyan Emanation) within the gain medium is created. Because the gain medium may have a high absorption efficiency for this specific bandgap of light, electrons throughout the structure may become energized. As the electrons become energized, they may move from their charged position to a discharged energy level. This movement of electrons may consequently release energy in the form of photons. These photons make up the photonic energy that is emitted from the gain medium. This newly emitted energy may then be prevented from exiting the top face of the gain medium because of the dichroic mirror. This photonic energy may then instead become focused on the face of the photoelectric material.

This dichroic coating may also be tuned to reflect light that is within the UV and Infrared Spectrum as well. This decreases the risk for damage to the components of the solid-state device.

Another option may be to use an antireflective coating to allow for the seamless transmission of photonic energy within the peak absorption spectrum of both the gain medium and the photoelectric material. This coating may be comprised of various materials that increase the transmissive ability of photonic energy by decreasing associated losses accompanied by reflection. This may increase the total amount of photonic energy that is able to enter the gain medium, as well as the photoelectric material.

Another option may be a cold mirror to allow for the creation of a virtual resonating cavity. This coating may be tuned to reflect and transmit specific wavelengths of light at a specific incident angle. When light that is within the peak absorption spectrum of the gain medium stimulates the mirror, it may permeate the material at a specific incident angle. Any light that is not absorbed readily by the gain medium, may be reflected at a specific incident angle into the system for a second chance at absorption by the gain medium. This may allow for Saiyan Emanation to take place within the gain medium as it reaches saturation potential.

This solid-state device may also be comprised with a photoelectric material that may or may not have coatings deposited on either face. The purpose of the photoelectric material is to absorb photonic energy either from ambient sunlight, and/or from the light emitted by the stimulated gain medium. The photoelectric material may also require a coating that allows for seamless transmission of photonic energy. This coating may be a dichromatic, antireflective, or any other type of coating design that allows for photonic energy within the peak absorption spectrum of the photoelectric material to freely enter with minimal reflection losses. If using an antireflective coating, this coating may function as an index matching coating that decreases reflection losses when photonic energy exits the gain medium and enters the photoelectric material.

The photoelectric material may also be comprised with a coating on the back face as well. This coating may be a highly reflective coating, a dichroitic coating, or any other type of optical coating material that minimizes the amount of light that is lost through the back face. The trapping of photonic energy within the solid-state exemplary embodiment allows for more photonic energy to become available within the device to either become absorbed into the photoelectric material, or to create stimulated emission (Saiyan Emanation) within the gain medium.

If the back side of the reaper or gain medium were not coated, then the device may use the back face as another absorption face. This back side may absorb photonic energy reflected from the ground or off a mirror that is strategically placed to reflect photonic energy into this back face. This may be known as bifacial pumping, where two or more faces of the reaper are used to capture and absorb photonic energy.

As the photoelectric material absorbs photonic energy that is within its peak absorption spectrum, the photonic energy may then stimulate movement of electrons within the material. These freely flowing electrons then travel down the material in the form of an electric current. This electric current may then be processed through a circuit board in the form of usable energy that may be applied in a variety of use cases.

How it can be Made:

This exemplary embodiment is composed of a variety of materials that may be composed of a variety of different molecular and chemical compounds. Each molecular and chemical compound is intrinsic to the solid-state device in the sense that these chemical bonds are what allow for the efficient conversion of photonic energy into usable electrical energy.

Coatings

Dichromatic Coating: This may be composed of a variety of different materials. The chemical or molecular compound is selectively permeable to light that is within the peak emission wavelengths of the sun. This wavelength consequently may also be within the bandgap of the solid-state device's gain medium's peak absorption.

This coating is applied to the polished surface of the gain medium. There are multiple ways to adhere this coating to the exemplary embodiment. One of which includes evaporating the chemical or molecular compound evenly across the surface. This allows for the coating to bond to the material seamlessly which may enhance its overall effectiveness.

There are a variety of processes that may be used to evaporate this compound onto the surface of the substrate. Some of which include, but are not limited to, electron beam sputtering, electron beam physical vapor deposition, ion assisted deposition, ion beam sputtering, or any other type of optical coating process that allows for the effective distribution of dichroitic coatings.

A possible process when using an ion beam sputtering technique is as follows:

Using a vacuum chamber and a target material (a metal oxide or any other type of material that releases electrons), a high energy ion beam is directed at the target. The ions within the beam may transfer their momentum into the target material causing atoms or molecules to sputter off. These high energy atoms/molecules that may sputter off the target material may deposit onto the substrates. Uniform, high density coatings may be achieved due to the presence of low-pressure oxygen within the coating to re-oxidize any free molecule or atom that may have become dissociated during the sputtering process.

The resulting coating may be an extremely smooth, clean surface finish that may also withstand temperature and humidity fluctuations within its environment.

Anti-Reflective Coatings: These coatings are applied to the faces of the gain medium and the photoelectric material. Having both materials coated with this anti-reflective coating may allow for the solid-state device to decrease its overall loss in photonic energy. They allow for the materials to reach the point of saturation and then allows the light to exit to prevent over saturation.

This coating is applied to the polished surface of the gain medium. There are multiple ways to adhere this coating to the exemplary embodiment. One of which includes evaporating the chemical or molecular compound evenly across the surface. This allows for the coating to bond to the material seamlessly which may enhance its overall effectiveness.

There are multiple ways to effectively bond this type of coating upon the surface of the substrate. For instance, electron beam sputtering, electron beam physical vapor deposition, ion assisted deposition, ion beam sputtering, or any other type of coating process that allows for the effective and efficient deposition of antireflective coatings upon the surface of a substrate. When using electron beam sputtering, a possible adhering process is as follows.

To initiate this process, the coating material may be heated within a high vacuum chamber until it becomes vaporized. It may be heated through electron beam bombardment when using dielectrics, or it may be heated resistively when using metals. As the coating material vaporizes, vapor may then stream away and recondense onto the surface of the substrate intended for coating.

Another process that may be utilized when using electron beam sputtering includes electron-beam physical vapor deposition. This may allow for coating at a high deposition rate without needing to heat the substrate at such high temperatures. When initiating this coating process, an electron beam may be generated and accelerated to a high kinetic energy. This high energy beam may then be directed at the evaporation material causing the electrons within the material to decrease unto a lower energy level. Interactions with the evaporation material causes kinetic energy to become converted into alternative forms of energy. Thermal energy may be one of the alternative forms of energy and may conduct heat into the evaporation material causing it to melt. The melt may then vaporize and rise to coat the surface of the substrate.

Highly Reflective Coatings: This may be composed of a variety of different materials. The chemical or molecular compound may act as a mirror within the solid-state device. This coating's reflective properties that may either reflect all wavelengths or may selectively reflect light that is within the gain medium's peak absorption bandgap. This allows for the continuous stimulation emission within the gain medium of the solid-state device. As the initial photonic energy saturates the material and exits, excess photonic energy may then be reflected to initiate stimulated emission within the gain medium.

This coating may be located on the side furthest from the surface dichromatic layer. This allows for the ability for enhanced trapping of the gain medium's primary excitation wavelengths. With this ability to control and reflect this light, the exemplary embodiment's ability to initiate stimulated emission may be substantially improved.

This coating is applied to the polished surface of the gain medium. There are multiple ways to adhere this coating to the exemplary embodiment. Of which may include, but are not limited to, electron beam sputtering, electron beam physical vapor deposition, ion assisted deposition, ion beam sputtering, or any other type of coating process that allows for the effective and efficient deposition of highly reflective coatings upon the surface of a substrate.

A possible process when using an ion beam sputtering technique is as follows:

Using a vacuum chamber and a target material (a metal oxide or any other type of material that releases electrons), a high energy ion beam is directed at the target. The ions within the beam may transfer their momentum into the target material causing atoms or molecules to sputter off. These high energy atoms/molecules that may sputter off the target material may deposit onto the substrates. Uniform, high density coatings may be achieved due to the presence of low-pressure oxygen within the coating to re-oxidize any free molecule or atom that may have become dissociated during the sputtering process.

The resulting coating may be an extremely smooth, clean surface finish that may also withstand temperature and humidity fluctuations within its environment.

Gain Medium

Crystalline-Lattice structure: This molecular compound may have a specific orientation and lattice structure that allows for the process of spontaneous emission to be controlled and modified into stimulated emission (Saiyan Emanation).

Possible crystals: There are many crystals that may have gain potentials that embody the characteristics listed above. Some of these crystals may include Ti³⁺: Al₂O₃, Nd: YAG, Cs: YAG, or any other crystal/chemical compound that has an intrinsic gain potential.

The gain medium may be cut, fabricated, polished, and coated before it is able to effectively provide a gain potential.

The gain medium may be spherical, rectangular, triangular, or any other type of crystalline configuration that allows for the harnessing and amplification of photonic energy.

The gain medium may also be cut at a specific incident angle that may allow for the seamless transmission of light with minimal reflection losses. This angle may be a Brewster Angle, or any other type of configuration that decreases reflection and allows for seamless transmission of light into the gain medium.

Photoelectric Material

This is the site where the photoelectric effect takes place within the solid-state device. The material that is used here may be highly excitable by photonic energy. The material may also be specifically excited by specific wavelengths of light. For instance, this material may be selectively excited by the peak emission bandgap of the gain medium associated with this solid-state device. This allows for the newly created photonic energy from the gain medium to excite the electrons within the photoelectric material generating a useable electric current.

Chemical composition: This material may be composed of a variety of different chemical or molecular compositions. Of which, specific chemical or molecular compounds such as GaAs, InGaN, GaInP, polycrystalline silicon, SiN, CdTe, or any other chemical compound that may partake in the photoelectric effect. Another important characteristic of the material may be for its peak absorption bandgap to match the associated gain medium's peak emission bandgap.

Assembly: This material may be coated with an antireflective coating, dichromatic coating, or any other coating that decreases the amount of photonic energy that is lost due to reflection. This prevents the loss of photonic energy that is necessary to stimulate the movement of electrons within the material. By having this coating, the necessary light is directed and evenly distributed across the faces of the photoelectric material. This increases the instances of freely moving electrons allowing the conversion of photonic to electrical energy to become increasingly more efficient. There may also be a highly reflective mirror that lies on the back of the solid-state device. This allows for light not initially absorbed by the gain medium to be directed back into the crystal to initiate continued stimulated emission.

Coatings may be deposited using electron beam physical vapor deposition, ion assisted deposition, ion beam sputtering, or any other type of coating deposition process that allows for the effective distribution of coatings onto the faces of the photoelectric material.

The coatings may be evaporated evenly over the faces of the photoelectric material. This allows for the coating to evenly act on the entire face of the material increasing the amount of available surface area for the photovoltaic effect to continuously occur. The photoelectric material is then effectively adhered to the back of the gain medium. This may be done using a resin whose index of refraction matches the gain medium allowing for light to seamlessly pass through onto the face of the photoelectric material.

As light enters the gain medium, it may allow for stimulated emission (Saiyan Emanation) to occur within the gain medium. Newly generated energy may exit the medium in the form of its peak emission bandgap. This light may then become readily absorbed by the photoelectric material. Once the photonic energy undergoes the photoelectric effect within this material, electrical energy may be harnessed and implemented into a variety of use cases.

It should be understood that all of the embodiments and examples described herein are merely exemplary and should be considered as non-limiting.

What is claimed is:

1. An apparatus substantially as described herein.

2. A system substantially as described herein.

3. A method substantially as described herein.
